(19) United States
(12) Patent Application Publication
(10) Pub. No.: US 2015/0343675 A1
(43) Pub. Date: Dec. 3, 2015

(54) DIRECT LAMINATION IN AUTOMOTIVE THERMOPLASTIC POWDER SLUSH CASTING PROCESS

(71) Applicants: Kelvin S. Gray, St. Clair, MI (US); James D. Shipton, Auburn Hills, MI (US)

(72) Inventors: Kelvin S. Gray, St. Clair, MI (US); James D. Shipton, Auburn Hills, MI (US)

(21) Appl. No.: 14/289,042

(22) Filed: May 28, 2014

(51) Int. Cl. B29C 41/18; B29C 41/22; B29C 41/46; B29C 44/12; B29C 44/56

(52) U.S. Cl. CPC B29C 41/18; B29C 44/1285; B29C 44/5681; B29C 41/46; B29C 41/22; B29K 2101/12

(57) ABSTRACT

A method for forming a molded article of a vehicle that includes providing a mold including a molding surface, the molding surface having a shape that corresponds to that of the molded article; heating the mold to a temperature in the range of 300 degrees F. to 450 degrees F.; conducting a first slush molding step to attach a first thermoplastic material to the molding surface; conducting a second slush molding step to attach a second thermoplastic material to the molding surface, the second thermoplastic material including a blowing agent; and laminating a substrate to the second thermoplastic material while the second thermoplastic material is in a molten state and the blowing agent is releasing a gas to foam the second thermoplastic material. The first thermoplastic material forms an exterior surface of the molded article, and the second thermoplastic material forms an interior foam of the molded article.

### FIELD

The present disclosure relates to slush molding.

### BACKGROUND

Slush molding is a molding process that enables thermoplastic products to be manufactured with very detailed and often complex shapes. A prime application for this process is the manufacture of vehicle dashboard “skins” that are ultimately back-filled with a foam system, providing the finished product with the necessary rigidity. The technique allows parts to be made with a single “cosmetic” side. It can also be used to make hollow parts, if necessary.

A variety of materials can be processed using this technique, but most often polyvinyl chloride (PVC), thermoplastic polyurethane (TPU) and thermoplastic polyolefins (TPO) are employed, depending upon the final performance specification. The actual molding material may be a plastisol or a powder. If a rotational technique is used, the material is charged into the mold and then the mold is tumbled while, at the same time, its temperature is elevated. Alternatively, the material are to be sprayed into the mold. Either process encourages the molding material to form a skin on the mold surface, which then becomes the molded part. Once the part is fully formed, the mold is cooled and the part can be peeled from the surface of the mold.

### SUMMARY

The present disclosure provides a method for forming a molded article of a vehicle that includes providing a mold including a molding surface, the molding surface having a shape that corresponds to that of the molded article; heating the mold to a temperature in the range of 300 degrees F. to 450 degrees F.; conducting a first slush molding step to attach a first thermoplastic material to the molding surface; conducting a second slush molding step to attach a second thermoplastic material to the molding surface, the second thermoplastic material including a blowing agent; and laminating a substrate to the second thermoplastic material while the second thermoplastic material is in a molten state and the blowing agent is releasing a gas to foam the second thermoplastic material, The first thermoplastic material forms an exterior surface of the molded article, and the second thermoplastic material forms an interior foam of the molded article.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIGS. 1A to 1G illustrate a slush molding system and method according to a principle of the present disclosure.

### DETAILED DESCRIPTION

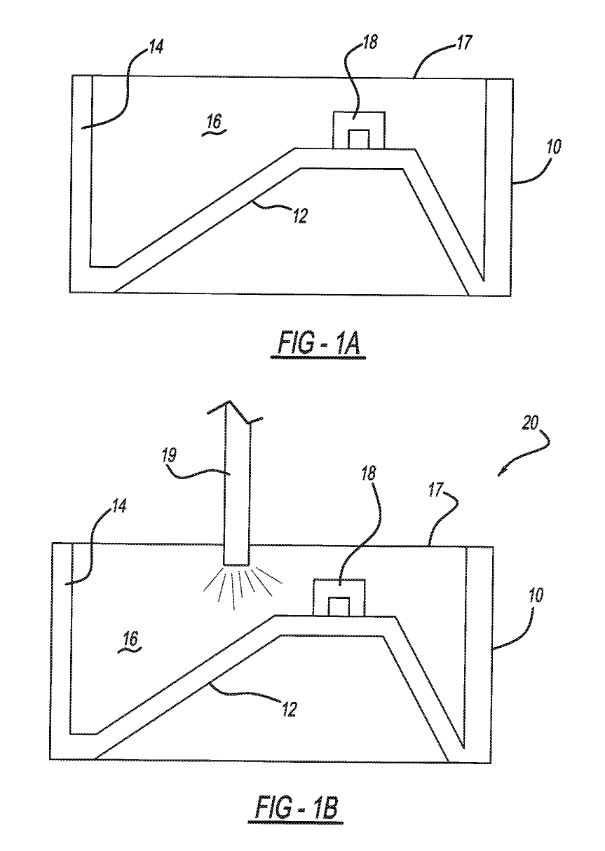

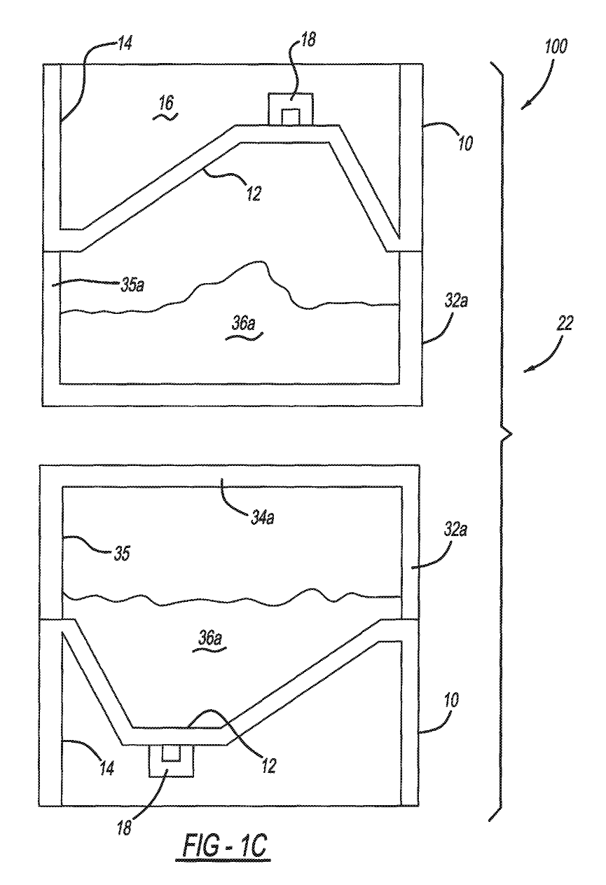

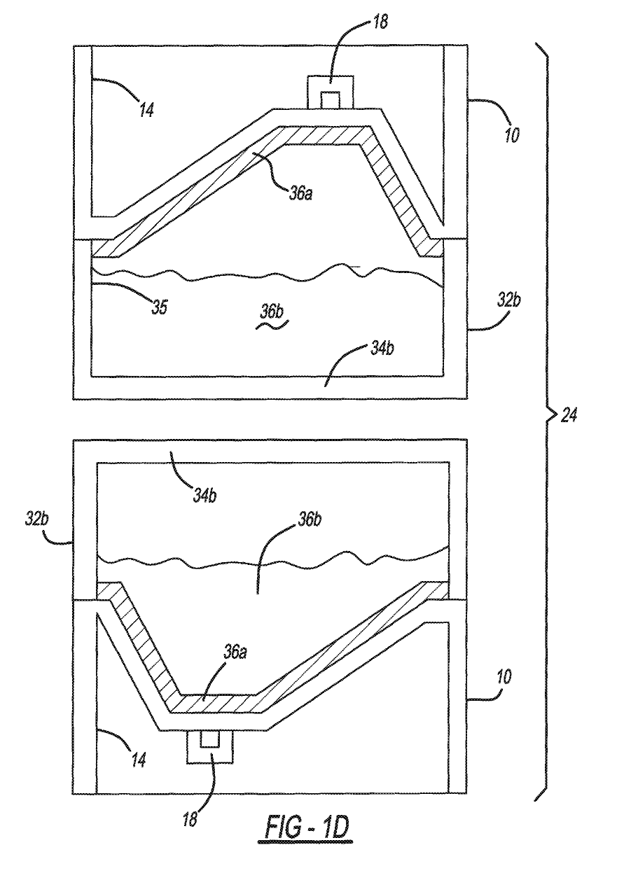

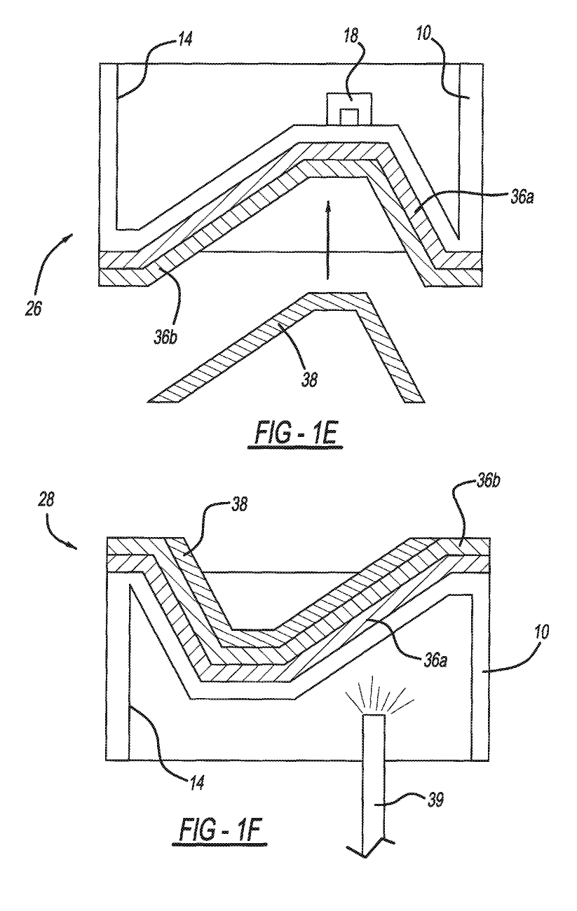

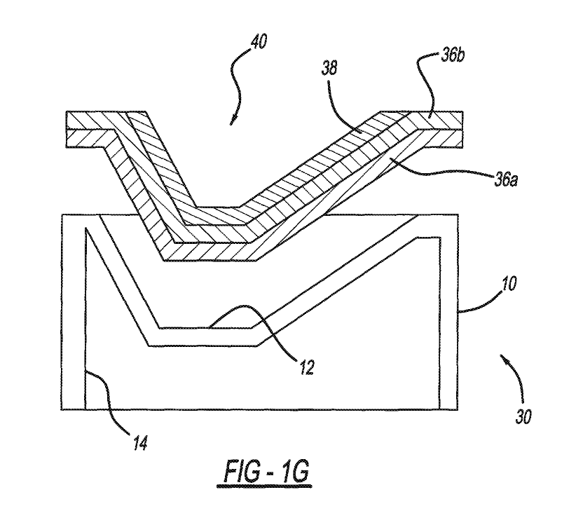

The present disclosure is directed to slush molding. FIGS. 1A-1G illustrates a slush molding system 100 according to a principle of the present disclosure. Slush molding system 100 includes a molding shell or member 10 (FIG. 1A) that is preferably formed from a metal material such as nickel (Ni), and defines a molding surface 12 that is shaped to correspond to the dimensions of the final molded part. Molding surface 12 is attached to a box-like frame 14 that defines a hollow interior 16. Molding surface 12 can be textured, which will dictate both the texture and the appearance of the exterior surface of the final molded article. Accordingly, molding surface 12 is formed to have any shape and contour as desired by one skilled in the art. Frame 14 includes a plurality of an opening 17 that allow for communication with a fluid such as air or water that can be used to heat and/or cool molding surface 12 during the slush molding process. Frame 14 includes a hook 18 that allows molding member 10 to be moved through a plurality of stations and rotated during the slush molding process.

In this regard, slush molding system 100 includes plurality of stations including a first station 20 (heating station 20—FIG. 1B), a second station 22 (first slush molding station 22—FIG. 1C), a third station 24 (second slush molding station 24—FIG. 1D), a fourth station 26 (lamination station 26—FIG. 1E), a fifth station 28 (cooling station 28—FIG. 1F), and sixth station 30 (article removing station 30—FIG. 1G). Firstly, molding member 10 is transferred via a robot, crane, or other type of conveying device (not shown) that grasps hook 18 and locates molding member 10 at heating station 20 (FIG. 1B). At heating station 20, molding member 10 is heated to a temperature that ranges between 300 degrees F. to 450 degrees F. Molding member 10 is heated by feeding a heated fluid such as air into opening 17 with a heating device 19, or molding member 10 is heated by induction heating. Once molding member 10 is heated, molding member 10 is grasped by conveying device and transferred to a first slush molding station 22.

At first slush molding station 22 (FIG. 1C), molding member 10 is coupled to a first slush feeding device 32a. First slush feeding device 32a includes a tank 34a that contains materials 36a in powder form therein. Extending outward from tank 34a is a connection surface 35 that couples to frame 14 via various coupling mechanisms (not illustrated) that are well known to one skilled in the art. A seal (not shown) ensures that materials 36a do not escape from slush feeding device 32a and molding member 10 when molding member 10 and slush feeding device 32a are rotated, as will be described in more detail later. Materials 36a held within tank 34a include thermoplastic materials such as thermoplastic elastomers (TPE), thermoplastic olefins (TPO), and thermoplastic urethanes (TPU). It should be understood, however, that other materials such as plasticizers and surfactants may also be added to tank 34a without departing from the scope of the present disclosure. Regardless, the materials 36a held within tank 34a are selected to form an exterior surface of the molded article.

Once molding member 10 is coupled to slush feeding device 32a, the molding member 10 and slush feeding device 32a are rotated to invert the molding member 10 and slush feeding device 32a, as is known in the art. Inversion of molding member 10 and slush feeding device 32a allow the materials 36a to come into contact with the heated molding member 10. As the powdered materials 36a contact the heated molding surface 12, the powdered materials 36a will liquefy and distribute over the heated molding surface 12. To assist in ensuring that the molding surface 12 is properly covered by the molten materials 36a, molding member 10 and slush feeding device 32a may be agitated (vibrated) during inversion thereof. In addition, the time that molding member 10 and slush feeding device 32a are inverted is monitored, and the number of inversions can be controlled to ensure that materials 36a have satisfactorily covered molding surface 12 to form the exterior surface of the molded article. The exterior surface, preferably, has a thickness that ranges between 0.1 mm to 0.5 mm. Other thicknesses, however, are contemplated.

As an alternative to the rotational technique described above, it should be understood that materials 36a may be sprayed into molding member 10. Regardless, once it is determined that the materials 36a have satisfactorily covered molding surface 12, molding member 10 and slush feeding device 32a are rotated to a non-inverted orientation, which allows non-melted materials 36a to return to tank 34a. Molding member 10 is then decoupled from slush feeding device 32a, and moved by conveying device to second slush molding station 24 (FIG. 1D). Alternatively, before molding member 10 is moved to second slush molding station 24, molding member 10 can be moved back to heating station 20 to re-heat molding member 10 to ensure that molding member 10 remains at the desired temperature.

At second slush molding station 24, molding member 10 is coupled to a second slush feeding device 32b. Second slush feeding device 32b is substantially similar to first slush feeding device 32a and includes a second tank 34b. Materials 36b held within tank 34b, however, include thermoplastic materials such as thermoplastic elastomers (TPE), thermoplastic olefins (TPO), and thermoplastic urethanes (TPU), as well as a chemical blowing agent such as azodicarbonamide. Materials 36b, in particular, are selected for their suitability in forming foams.

Once molding member 10 is coupled to slush feeding device 32b, the molding member 10 and slush feeding device 32b are rotated to invert the molding member 10 and slush feeding device 32b. Inversion of molding member 10 and slush feeding device 32b allow the materials 36b to come into contact with the heated molding member 10. As the powdered materials 36b contact the heated molding surface 12, the powdered thermoplastic of materials 36b will melt and distribute over the heated molding surface 12 including the previously-applied materials 36a. In addition, because the mold member 10 is pre-heated to a temperature that ranges between 300 degrees F. and 450 degrees F., the blowing agent will begin to reach the temperature at which gas will be released to foam the liquefied thermoplastic material. The time that molding member 10 and slush feeding device 32b are inverted can be monitored, and the number of inversions can be controlled to ensure that materials 36b have satisfactorily covered the materials 36a. Preferably, the second materials 36b are deposited such that the resultant foam will have a thickness that ranges between 2 mm and 5 mm.

As an alternative to the rotational technique described above, it should be understood that materials 36b may be sprayed into molding member 10. Regardless, once it is determined that the materials 36b have satisfactorily covered the materials 36a, molding member 10 and slush feeding device 32b are rotated to a non-inverted orientation, which allows non-melted materials 36b to return to tank 34b. Molding member 10 is then decoupled from slush feeding device 32b, and moved by conveying device to lamination station 26 (FIG. 1E). Alternatively, before molding member 10 is moved to lamination station 26, molding member 10 can be moved back to heating station 20 to heat molding member 10 to ensure that molding member 10 remains at the re-desired temperature.

Once reaching lamination station 26, a substrate 38 is mated with the materials 36b. Substrate 38 is shaped to correspond to molding surface 12, and is formed from thermoplastic materials such as PVC, polyethylene, polypropylene, polystyrene, and the like. Once substrate 38 is mated with materials 36b, a molded article is formed including an exterior surface, a foam, and the substrate 38. The molded article can be used for, for example, an interior panel for a vehicle, with the exterior surface being the surface that is exposed in the vehicle.

It should be understood that substrate 38 is mated with the materials 36b while the thermoplastic of materials 36b are in a molten state, or at least substantially in a molten state, and the chemical blowing agent is releasing gas to foam the thermoplastic. It is important that materials 36b remain in a substantially molten state during mating of substrate 38 and materials 36b to ensure sufficient adhesion between substrate 38 and materials 36b. A “molten state” includes a liquid state and states that are gel-like in nature such that substrate 38 will adhere to materials 36b. Once substrate 38 is laminated to materials 36b, the blowing agent will continue to release gas and complete the foaming of materials 36b between substrate 38 and materials 36a. To ensure that any excess gas that is produced is allowed to escape, substrate 38 can include small apertures formed therein (not shown). Regardless, the mating of substrate 38 to materials 36b while molten ensures adhesion of the materials 36b to the substrate 38, which increases productivity in comparison to previous methods that required additional steps of applying adhesives between the exterior surface and foam, and between the foam and substrate 38.

Once it is determined that the substrate 38 and materials 36b have satisfactorily adhered to each other, molding member 10 is then moved by conveying device from lamination station 26 to cooling station 28 (FIG. 1F). At cooling station 28, a fluid such as water or cooled air is fed into opening 17 using cooling device 39 to cool molding member 10. The cooling of molding member 10 allows for materials 36a and 36b to fully harden or cure, and causes any foaming that is still occurring to stop. Once it is determined that the molded article is satisfactorily cooled, molding member 10 is then moved to article removing station 30 (FIG. 1G) where the molded article 40 is removed from molding member 10. Molding member 10 is then returned to heating station 20 where the slush molding process can be repeated.

According to the above method, a molded article 40 including an exterior surface or skin 36a, a foam 36b, and a substrate 38 can be formed in one process in contrast to previous methods where a skin is molded, and then a foam and substrate are backfilled onto the skin using adhesives and the like. By omitting the backfilling steps and adhesives, the process for forming the molded article is simplified and production costs are lowered.

It should be understood that various steps and stations of the slush molding system 100 and method according to the present disclosure can be eliminated without departing from the scope of the present disclosure. For example, molded articles 40 that include only layer 36a and substrate 38 are contemplated by the present disclosure such that second slush station 24 and its associated steps can be omitted. Alternatively, molded articles 40 that include only layer 36b and substrate 38 are contemplated such that first slush station 22 can be omitted. In addition, it should be understood that a separate cooling station 28 may be omitted from the system and method in favor of a lamination station 26 that is configured to provide cooling after lamination of substrate 38.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
heating a mold member including a molding surface;
conducting a first slush molding step to attach a first material to the molding surface;
conducting a second slush molding step to attach a second material to the first material; and
laminating a substrate to the second material while the second material is in a molten state.

2. The method of claim 1, wherein the first material forms an exterior surface of a molded article.

3. The method of claim 2, wherein the second material forms a foam of the molded article.

4. The method of claim 3, wherein the second material includes a blowing agent.

5. The method of claim 1, wherein the first and second materials each include a material selected from the group consisting of thermoplastic elastomers, thermoplastic olefins, and thermoplastic urethanes.

6. The method of claim 1, wherein the second material includes a blowing agent, and blowing agent releases a gas during the laminating of the substrate to the second material.

7. The method of claim 6, wherein the substrate includes a plurality of apertures that allow the gas to escape during the laminating of the substrate to the second material.

8. The method of claim 1, further comprising heating the mold member after the first slush molding step.

9. The method of claim 1, further comprising heating the mold member after the second slush molding step.

10. The method of claim 1, further comprising cooling the molding member after the laminating of the substrate to the second material.

11. The method of claim 1, wherein the substrate is formed from a material selected from the group consisting of polypropylene, polyethylene, and polystyrene.

12. A method for forming a molded article of a vehicle, comprising:
providing a mold including a molding surface, the molding surface having a shape that corresponds to that of the molded article;
heating the mold to a temperature sufficient to melt first and second thermoplastic materials of the molded article;
conducting a first slush molding step to attach the first thermoplastic material to the molding surface;
conducting a second slush molding step to attach the second thermoplastic material to the molding surface, the second thermoplastic material including a blowing agent; and
laminating a substrate to the first and second thermoplastic materials while at least the second thermoplastic material is in a substantially molten state and the blowing agent is releasing a gas to foam the second thermoplastic material,
wherein the first thermoplastic material forms an exterior surface of the molded article and the second thermoplastic material forms a foam of the molded article.

13. The method of claim 12, wherein the first and second thermoplastic materials each include a material selected from the group consisting of thermoplastic elastomers, thermoplastic olefins, and thermoplastic urethanes.

14. The method of claim 12, wherein the blowing agent releases a gas during the laminating of the substrate to the second thermoplastic material.

15. The method of claim 14, wherein the substrate includes a plurality of apertures that allow the gas to escape during the laminating of the substrate to the second thermoplastic material.

16. The method of claim 12, further comprising cooling the molding member after the laminating of the substrate to the second thermoplastic material.

17. The method of claim 12, wherein the substrate is formed from a material selected from the group consisting of polypropylene, polyethylene, and polystyrene.

18. The method of claim 12, further comprising heating the mold member after the first slush molding step.

19. The method of claim 12, further comprising heating the molding member after the second slush molding step.
